(19) United States
(12) Patent Application Publication
(10) Pub. No.: US 2003/0114147 A1
(43) Pub. Date: Jun. 19, 2003

(54) Hold service on wireless calls

(76) Inventors: Stephen C. Goss, Wheaton, IL (US); Paresh Chhabildas Kanabar, Naperville, IL (US); Phillip Michael Sands, Champaign, IL (US)

Correspondence Address: Werner Ulrich, 434 Maple Street, Glen Ellyn, IL, 60137-3826, US

(21) Appl. No.: 10/017,210

(22) Filed: Dec. 13, 2001

(51) Int. Cl. H04M 3/42

(52) U.S. Cl. 455/414; 455/445

(57) ABSTRACT

Apparatus and a method for temporarily disconnecting a cellular customer from a simple, three-way, or multi-party, calling connection. During the time of the disconnection, the disconnected customer can make another call; for example, to obtain information required in order to proceed with the initial call. The customer can then be re-connected on the initial call. The customer signals a request for the disconnect and the re-connect by dialing a special directing code, followed by the “Send” key. The directing code is interpreted by the Mobile Switching Center (MSC) to establish the required connections. Advantageously, this arrangement allows customers on simple connection or on three-way connections to interrupt a call in order to make a consulting call.

### TECHNICAL FIELD

This invention relates to the provision of hold service to wireless customers on simple or three-way calling connections.

Problem:

For land-line based customers, a hold feature is a very useful one. For example, it allows a party to a call to be temporarily disconnected from a call while the party confers with another station to determine information requested by the caller. After the party that has gone on hold has found the information, or finds that he/she is unable to find this information, he/she returns to the call. This facility can also be used on 3-way or conference calls. A problem of the prior art is that this type of facility is available in land-based telephony, but not in wireless telephony.

Solution:

Applicants have studied this problem and have recognized that in wireless telephony, in order to send any kind of signaling message from a wireless station, a “send” signal must be generated. A response to any kind of send signal in present wireless telephony if there is already a three-way connection is to drop the most recently added party of the three-way connection, and go to a two-way connection. For example, on a single connection, if the cellular party dials a number and then presses the “send” button, a three-way connection is established including the party identified by the dialed number as the third party of the three-way connection. If the cellular party presses the “send” button, but does not have 3-way or conference calling service, the “send” signal plus any other digits are ignored.

The above problem is solved and an advance is made over the teachings of the prior art in accordance with this invention, wherein a wireless party to a simple (two-way), three-way, or multi-party conference call, can request that his/her connection be placed on hold by dialing a special code followed by the “send”; the cell site and switch interpret this special code as an indication that the party that sent the code wishes to go to a hold state in the simple or three-way connection, while in the case of a three-way connection, the other two legs of the three-way connection remain undisturbed; subsequently, the held party, possibly after completing another call, can return to the simple or three-way connection by dialing another code, because the switch has maintained a record of the simple or three-way connection. Advantageously, a wireless party to a simple or three-way connection can then go on hold at will. From the hold state, the held party can then make another call. Thereafter, the party can go back to the simple or three-way call connection by sending another coded signal along with the send signal to request that the hold state be converted back to an active connection. In one preferred embodiment, the two special codes are the same, so that the special code, in effect, toggles the wireless party between the hold state and the active connection state.

### BRIEF DESCRIPTION OF THE DRAWING(S)

FIG. 1 is a block diagram illustrating the architecture of Applicants' invention; and

FIGS. 2 and 3 are flow diagrams illustrating the operation of Applicants' invention.

### DETAILED DESCRIPTION

Three-way calling is a service offered to wireless users as well as land-based users. In accordance with the principles of this invention, when a wireless user is on a three-way call and wishes to temporarily change the status of his/her connection to the three-way conference circuit used for implementing three-way calling from active to hold, that user dials a special code, for example, *5, followed by “send”. The switching system responds to this signal by temporarily de-activating the connection between the conference circuit and the user, and not sending voice signals between the user and the conference bridge. The user is then disconnected from the connection and is free to make another call. When, subsequently, the user re-dials another special code, the connection between the user and the conference circuit is re-activated. Between those two times, the user can make another call, for example, to obtain required information needed by the users of the three-way conference.

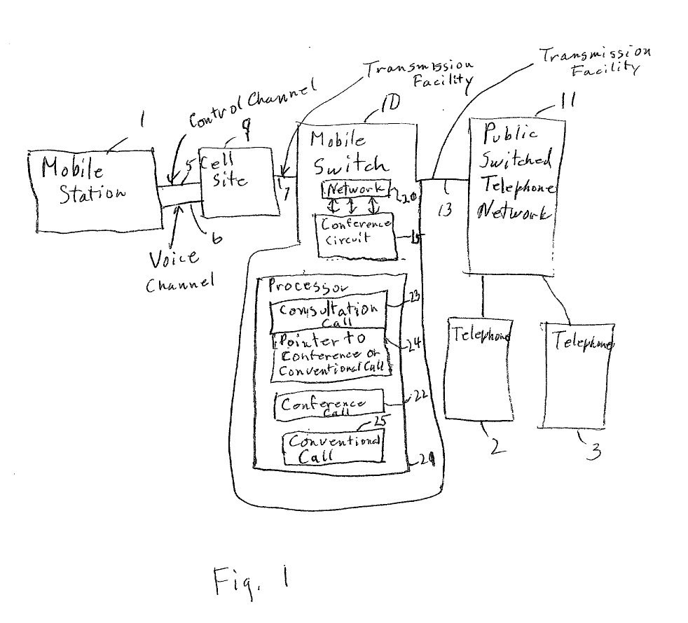

FIG. 1 is a block diagram showing the architecture of Applicants' invention. A Mobile Station (1) connected by a Control Channel (5) and a Voice Channel (6), to Cell Site (9) to a Mobile Switch (10) controlled by a Processor (21), wishes to initiate a three-way connection. (A different cell site can be used for transmitting control channel signals and voice channel signals to the Mobile Switch.) A three-way connection will be established through a Network (20), using a Conference Circuit (15) of the Mobile Switch. A record of the call is maintained in Conference Call Record (22). The other two parties to the three-way connection may be land based telephones or other mobile stations. In the example, the other two telephones are land based stations connected to the Mobile Switch (10) via the Public Switched Telephone Network (PSTN), and through a Transmission Facility (13). The other stations are Telephones (2) and (3).

The Mobile Switch (10) also maintains a Record (23) of any consultation call; the record includes a Pointer or other Link (24) to the conference call, and/or a port address for subsequently re-establishing the conference call. This record, including the Pointer, is maintained to simplify the process of re-patching the user's station to the suspended leg of the three-way conference.

This type of arrangement can also be used to permit a wireless party on a “conventional” call between two parties to temporarily suspend his/her connection, and make a consultation call. The record of the original call is maintained in Call Record (25) of the conventional call. When the wireless party disengages from the original call, for example, to make a consultation call, the Consultation Call Record (23) also contains a Pointer (24) to the conventional call record.

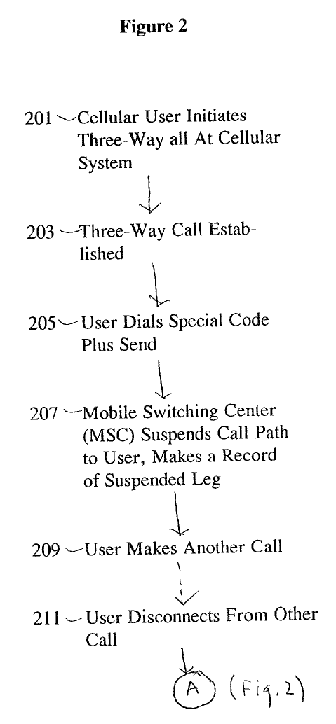

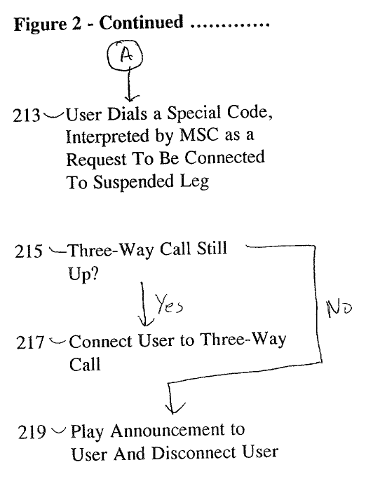

FIG. 2 illustrates the operation of Applicants' invention. A user initiates a three-way call at the cellular system, Action Block (201). The three-way call is established, Action Block (203). The user wishes to temporarily suspend his/her connection from the three-way conference, and does so by dialing a special code plus the “Send” key, Action Block (205). In response to receipt of this message, the Mobile Switching Center (MSC) suspends the call path to the user, and makes a record of the suspended leg or connection, Action Block (207). The user is then free to make another call, Action Block (209), and eventually, disconnects from that other call, Action Block (211). The user is now ready to re-join the three-way conference, and does so by dialing a special number interpreted by the MSC as a request to re-join a suspended connection, Action Block (213). The MSC tests whether the balance of the conference of the three-way call is still up, Action Block (215). If the balance of the three-way connection is still up, the MSC connects the user to the call, Action Block (217). If the other participants in the three-way conference have disconnected, then the MSC arranges to play an announcement to the user indicating that the conference is no longer active, and disconnects the user, Action Block (219).

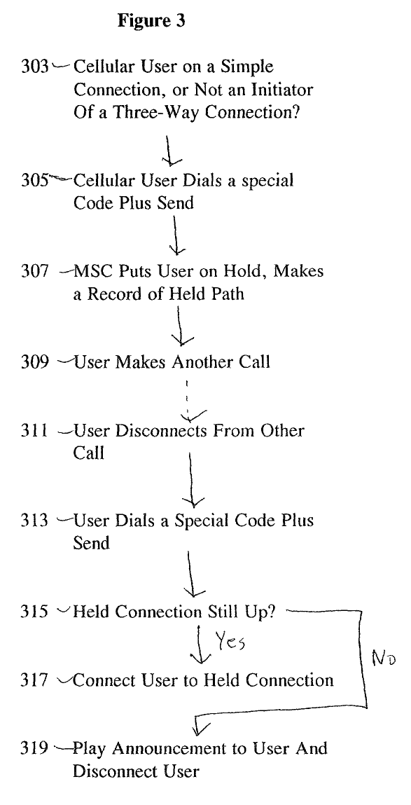

The same principles can be extended to cellular users who are not on a three-way connection. The basic idea is the same. If such a user wishes to consult a third-party in the middle of a conversation, the user dials a special code plus “Send” to alert the switch that the user wishes to be placed on hold in order to place a separate call; the switch will then put him/her on hold, receive dialing information, and establish a connection for the consultation. Subsequently, when the consultation has been completed, the consultation connection is disconnected and the user can request a re-connection to the original connection by dialing a special code. This is illustrated in the flow chart of FIG. 3.

FIG. 3 illustrates the actions performed in order to allow a user on a conventional call, or a user other than the initiator of the three-way connection on a three-way call, to be temporarily placed on hold in order to consult a separate party and then after the consultation connection has been terminated, to return to the original call. The call record of the consultation call should have an identification of the call record of the original two-party call or of the three-way call, or of the port to which the consulting party should be connected in case that consulting party disconnects and dials the special code. The cellular user is on a simple connection, or is on a non-originating leg of a three-way call, Action Block (303). Cellular user dials a special code plus “Send”, Action Block (305). In response to this special code plus “Send”, the Mobile Switching Center (MSC) puts the cellular user on hold and makes a record of the held path, Action Block (307). The user then makes another call, Action Block (309). Eventually, the user disconnects from the other call, for example, by pressing the “end” key, Action Block (311). If the user wishes to rejoin the original connection, the user, whose mobile station is still powered-on, then dials a special code plus “Send”, Action Block (313). The MSC then tests whether the held connection is still up, Action Block (315). The held connection would have been disconnected if the party to which that held connection was connected had disconnected. If the connection is still up, then the user is connected to the port assigned to the held connection, Action Block (317). If the held connection is no longer up, then an announcement is played to the user, and the user is disconnected, Action Block (319).

The above description is of one preferred embodiment of Applicants' invention. Other embodiments will be apparent to those of ordinary skill in the art without departing from the scope of the invention. The invention is limited only by the attached claims.

1. In a switching system for serving wireless customers, apparatus for temporarily suspending a connection from one leg of a conference connection, comprising:
means for temporarily disconnecting a mobile station connected to said leg, which sends a special indication in response to receipt of said indication;
means for making a record in said switching system of a port to which said leg was connected; and
means for subsequently re-connecting said mobile station to said leg of said conference connection, using said record, in response to receipt of a re-connect request message.

2. The apparatus of claim 1, further comprising means for connecting said mobile station previously connected to the suspended leg on another connection while said leg is disconnected from said mobile station.

3. The apparatus of claim 1, wherein said special indication and said re-connect request message comprise identical keyed characters.

4. The apparatus of claim 1, wherein said special indication comprises a dialed special code followed by a “send” code.

5. In a switching system for serving wireless customers, apparatus for temporarily suspending a connection from one of said wireless customers, comprising:
means for temporarily disconnecting the one customer which sends a special indication from said connection in response to receipt of said indication from said one customer;
means for making a record in said switching system of a port to which said one customer was connected; and
means for re-connecting said one customer to said connection from which said one customer was temporarily disconnected, using said record, in response to receipt of a re-connect message from said one customer.

6. The apparatus of claim 5, further comprising:
means for connecting said one customer to another connection while said connection is temporarily suspended.

7. The apparatus of claim 5, wherein said special indication and said re-connect request message comprise identical keyed characters.

8. The apparatus of claim 5, wherein said special indication comprises a dialed special code followed by a “send” code.

9. In a switching system for serving wireless customers, a method of temporarily suspending a connection from one leg of a conference connection, comprising:
in response to a receipt of a special indication from a mobile station connected to said leg, disconnecting said mobile station from said conference connection;
making a record in said switching system of a port to which said leg was connected; and
in response to receipt of a re-connect request message from said mobile station, re-connecting said mobile station to said leg of said conference connection using said record.

10. The method of claim 9, further comprising the step of connecting said mobile station previously connected to the suspended leg to another connection, while said leg is disconnected from said mobile station.

11. The method of claim 9, wherein the step of receiving said special indication and the step of receiving a re-connect message, each comprise the step of receiving identical keyed characters.

12. The method of claim 9, wherein the step of receiving said special indication comprises the step of receiving a dialed special code, followed by a “send” code.

13. In a switching system for serving wireless customers, a method for temporarily suspending a connection from one of said wireless customers, comprising the step of:
in response to receipt of a special indication from the one customer, temporarily disconnecting said one customer from said connection;
making a record in said switching system of a port to which said one customer was connected; and
in response to receipt of a re-connect message from said one customer, re-connecting said one customer to said connection, using said record.

14. The method of claim 13, further comprising the step of:
connecting said one customer to another connection while said connection is temporarily suspended.

15. The method of claim 13, wherein the step of receiving said indication from said one customer and the step of receiving said re-connect message, each comprise the step of receiving identical keyed characters.

16. The method of claim 13, wherein the step of receiving said special dialed indication, comprises the step of receiving a dialed special code, followed by a “send” code.
